(19) United States
(12) Patent Application Publication
(10) Pub. No.: US 2007/0235437 A1
(43) Pub. Date: Oct. 11, 2007

(54) Paint oven monitoring system

(76) Inventors: Joseph M. Klobucar, Ann Arbor, MI (US); James L. Pakkala, Livonia, MI (US); Gregory M. Still, Plymouth, MI (US); David L. DerMiner, Milford, MI (US)

Correspondence Address: HOWARD & HOWARD ATTORNEYS, P.C., THE PINEHURST OFFICE CENTER, SUITE #101, 39400 WOODWARD AVENUE, BLOOMFIELD HILLS, MI, 48304-5151, US

(21) Appl. No.: 11/541,978

(22) Filed: Oct. 2, 2006

Related U.S. Application Data
(60) Provisional application No. 60/789,371, filed on Apr. 5, 2006.

(51) Int. Cl. F27B 9/06

(52) U.S. Cl. 219/388; 219/413

(57) ABSTRACT

A paint oven including a conveyor conveying painted articles through the oven and a plurality of infrared temperature sensors directed toward and measuring the temperature of predetermined areas of the painted articles, and a control receiving a signal from the infrared temperature sensors and comparing the temperature to a predetermined standard. The disclosed embodiment further includes calibration targets opposite the infrared temperature sensors and independent temperature sensors measuring the temperature of the target for calibration of the infrared temperature sensors. The method of this invention further includes aligning the infrared temperature sensors with a coaxial light source.

### RELATED APPLICATIONS

This application claims priority to provisional application Ser. No. 60/789,371 filed Apr. 5, 2006.

### FIELD OF THE INVENTION

This invention relates to paint oven monitoring systems particularly suitable for monitoring the temperature of predetermined areas of painted vehicle bodies during the cure cycle.

### BACKGROUND OF THE INVENTION

As will be understood by those skilled in this art, the temperature in a paint cure oven may be critical to proper curing of the paint on a painted article. If the temperature is too high, the paint may become brittle and easily chip. If the temperature is too low, the paint may not fully cure. However, it is the temperature of the article in the paint oven which determines the quality of the cure. For example, in an automotive paint oven where vehicle bodies are conveyed on a conveyor through the oven, the painted vehicle body includes areas which require considerably more heat than other areas, such as the vehicle body rocker panels. Thus, for example, the paint on the rocker panels may not be fully cured, but the paint on the body panels having a thickness of only a few millimeters may be fully cured or over cured. Further, different types of painted vehicle bodies may be conveyed through the paint oven.

The current industry standard for measuring the temperature of painted objects in a paint cure oven, such as painted vehicle bodies, is to magnetically attach thermocouple probes at predetermined locations to the surfaces of the object. There are products specifically designed for this type of temperature measurement. For example, the “Oven Tracker” system made by DataPaq, Inc. of Wilmington, Mass. includes magnetic probes which are attached to the body and a data logger which travels with the vehicle body and records the temperature of the probes. Because the probes are magnetically adhered to the vehicle body, they cannot be applied to a freshly painted vehicle body, but must be used with a non-production or scrap vehicle body to determine the temperature of the vehicle body in the oven. The probes are typically disbursed around a vehicle body at predetermined spaced locations. However, this temperature measurement is not performed often and is not used for production vehicles because the probes must be attached to the outside of the vehicle body and because of the difficulties associated with placing the probes around the vehicle body and wiring the probes to the data logger.

Infrared temperature sensors or sensing systems for monitoring the temperature of objects have been attempted for a variety of industries, but have not been used in mass production applications, particularly for measuring the temperature of painted articles in a paint oven or more specifically for vehicle body paint cure ovens.

As will be understood from the above description, there has been a long felt need for a temperature monitoring and control system for paint ovens, particularly including vehicle body paint cure ovens, which may be utilized on a continuous basis to accurately measure the temperature of predetermined areas or locations of the painted article.

### SUMMARY OF THE INVENTION

This invention relates to a paint cure oven having a temperature monitoring and control system and a method of monitoring the temperature of predetermined areas or locations of painted articles, particularly, but not exclusively, painted vehicle bodies. In a preferred embodiment, the paint oven includes a heated oven enclosure, a conveyor conveying painted articles through the oven enclosure curing the paint on the articles, and a plurality of infrared temperature sensors preferably located within the heated oven enclosure, directed toward and measuring the temperature of predetermined areas of the painted articles conveyed through the heated oven enclosure. In a preferred embodiment of the paint oven of this invention, the infrared temperature sensors are adjustably mounted within the paint oven. In the disclosed embodiment, the infrared temperature sensors are mounted in ball or sphere permitting adjustment of the orientation of the infrared temperature sensors by rotating the ball mount, which is then locked in place after adjustment of the ball mount to direct the infrared temperature sensors to predetermined locations on the painted article. In one preferred embodiment, the paint oven further includes a control receiving a signal from the infrared temperature sensors which may compare the temperature sensed by the infrared temperature sensors with a predetermined standard and signal the operator when the temperature sensed is outside of a predetermined range. The control may thus be utilized to signal an operator that the temperature must be adjusted or the control may be connected to the oven control to automatically adjust the oven temperature to avoid over curing or under curing. The control may also be utilized to recognize the painted object. For example, the temperatures sensed by the plurality of infrared temperature sensors will normally be within predetermined ranges for each model of vehicle bodies, providing a “signature” to the control. The control may then compare the signature of temperatures measured with a standard for each type of vehicle body and record the number of each vehicle body types transferred through the oven and select the standard that most closely matches the temperatures measured. The control may then compare the temperatures measured or sensed by the infrared temperature sensors with the predetermined standard for the selected type of vehicle body and signal the operator when the temperatures sensed is outside a predetermined range.

In one preferred embodiment, the paint oven further includes a calibration target or a plurality of calibration targets opposite the infrared temperature sensors, preferably on a side of the conveyor opposite to the infrared temperature sensors, such that the infrared temperature sensors measure the temperature of the calibration targets when the painted article on the conveyor does not block the view of the infrared sensors of the calibration target. In a more preferred embodiment, the calibration target further includes an independent temperature sensor for calibration of the infrared temperature sensors although this feature is optional because infrared temperature sensors are quite reliable.

In one preferred embodiment of the paint oven of this invention, the infrared temperature sensors and control are located in housings or cabinets on opposed sides of the conveyor. In this embodiment, the calibration targets are located on the same cabinets containing the infrared temperature sensors, such that the housings each include an array of infrared temperature sensors and a calibration target. In the disclosed embodiment, the cabinets include a vertical array of infrared temperature sensors and vertical calibration targets.

The method of monitoring the temperature of painted articles in a paint oven of this invention thus includes conveying the painted article through a heated paint oven, measuring the temperature of predetermined areas of the painted articles by directing infrared temperature sensors at the predetermined areas, and transferring the data from the infrared temperature sensors to a control, wherein the control may compare the temperatures measured by the infrared temperature sensors with a predetermined standard. As set forth above, the control may then be used to signal the oven operator or to directly control the temperature of the oven. The method of this invention may further include directing the infrared temperature sensors to a calibration target to measure the temperature of the calibration target and independently measuring the temperature of the calibration target to calibrate the infrared sensors. The method of this invention can also be carried out on a continuous basis. The calibration target or targets may be mounted inside the oven such that the infrared temperature sensors observe the target when no painted article blocks the view of the infrared sensors. The temperature of the calibration targets may be measured by thermocouples, resistance temperature detectors (RTD) or other conventional temperature sensors. The paint cure oven and method of this invention may also include an optical or proximity sensor or position sensor to detect the presence, position or configuration of the painted articles. This sensor, which may be a laser, may be desirable to provide accurate information about the position of the painted articles in relation to the infrared temperature sensors or the type of article, such as a different vehicle body

During periods when no painted object is in front of the infrared temperature sensors, the electronic control system may compare the signal from the infrared sensors to the temperature independently measured on the calibration targets. If the signal from the infrared sensors disagrees with the temperature measured on the calibration targets beyond some predetermined limit, the electronic control may signal the operator that the infrared signal is out of calibration, correct the infrared signal by applying or adjusting a mathematical correction factor, or record the readings along with the information about the date, time and other condition for future verification.

The method of this invention may further include aligning the infrared temperature sensors with a light source, such as a laser. In this embodiment, a laser is aligned, preferably coaxially aligned, with the infrared temperature sensor and directed toward a predetermined location on the painted article. In this embodiment, the infrared temperature is mounted in an adjustable mount, such as a ball mount, and the laser is aligned with the predetermined location on the painted article. The alignment of the infrared temperature sensor is then locked in place and the laser in then removed.

The paint oven and method of monitoring a paint oven and the meritorious features of this invention will be more fully understood from the following description of the preferred embodiments and the appended drawings, a brief description of which follows.

### BRIEF DESCRIPTION OF THE DRAWINGS

FIG. 1 is a partially schematic end view of one embodiment of a paint oven of this invention;

FIG. 2 is a side perspective view of one embodiment of a housing for infrared temperature sensors and including a calibration target;

FIG. 3 is another view of the housing shown in FIG. 2 with the door open, illustrating one embodiment of an infrared temperature sensor adjustable mounting;

FIG. 4 is one embodiment of an adjustable mounting for an infrared temperature sensor;

FIG. 5 is an exploded view of the sensor and mounting assembly shown in FIG. 4; and

FIG. 6 is a side perspective view of the mounting assembly of FIG. 4, including an alignment laser.

### DESCRIPTION OF THE PREFERRED EMBODIMENTS

The following description of the preferred embodiments of this invention is for illustrative purposes only and does not limit this invention except as set forth in the appended claims. As will be understood by those skilled in this art, various modifications may be made to the paint oven and method of monitoring a paint oven of this invention as further described below.

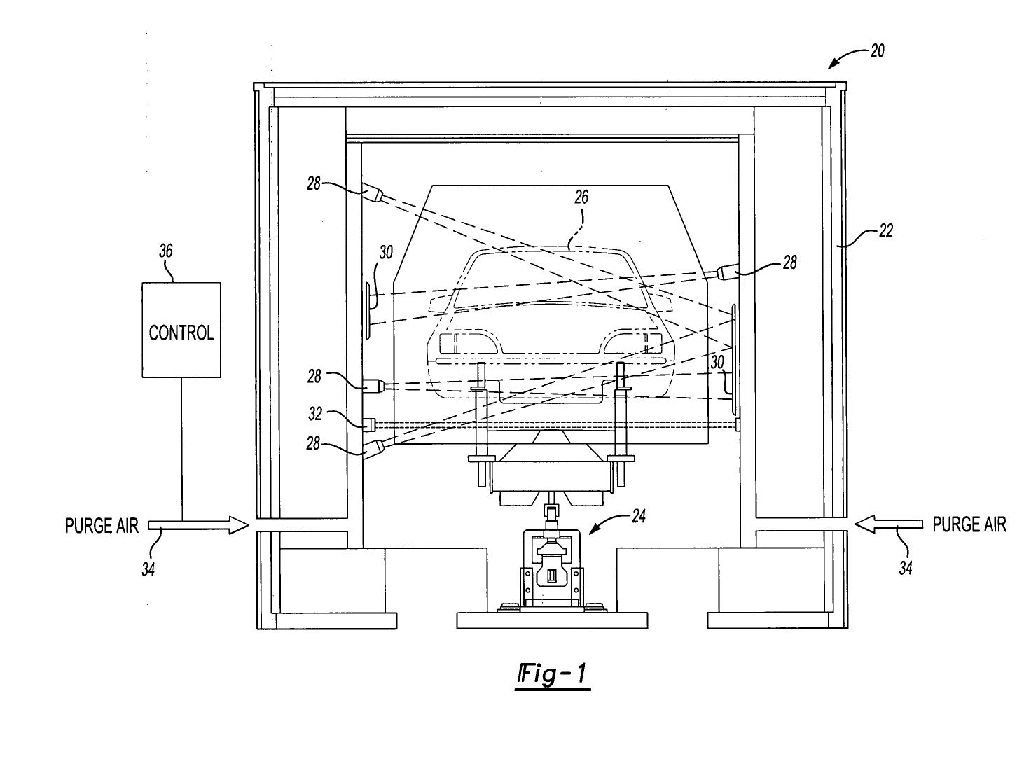

The paint oven 20 illustrated in FIG. 1 may be conventional for curing the paint on vehicle bodies and includes an enclosure 22 having a central conveyor 24 conveying a painted vehicle body 26 for curing the paint. However, the paint oven and method of monitoring the temperature of painted articles of this invention is not limited to vehicle paint ovens or a method of monitoring the temperature of a painted vehicle body. The problems associated with a vehicle paint oven, however, are illustrative of the problems associated with monitoring and control of the temperature of a paint oven. As set forth above, a vehicle body includes areas of very different metal thicknesses which heat at very different rates. For example, the rocker panels and pillars may be an ⅛ inch thick or greater, whereas the body panels may be only a few thousandth's of an inch in thickness. Thus, the body panels will heat to the paint curing temperature much faster than the rocker panels and pillars. Thus, it is imperative to monitor the temperature of the different areas of the vehicle body, preferably on a continuous basis, to assure proper curing of the paint on the vehicle body. As set forth above, the current industry standard for measuring the temperature of objects in a paint cure oven is to attach thermocouple probes to the surface of the object which is not possible with production vehicles. The paint oven and method of monitoring the temperature of painted articles in a paint oven of this invention solves this problem and fulfills the long felt need for continuously monitoring the temperature of predetermined areas of a painted article in a paint cure oven as now described.

The embodiment of the paint cure oven 20 shown in FIG. 1 includes an oven enclosure 22 having a conveyor 24 for conveying painted articles, such as the vehicle body 26 shown through the paint oven 20. The paint oven of this invention includes a plurality or array of infrared temperature sensors 28 which are directed toward predetermined areas of the vehicle body 26 to monitor the temperature of these areas. In this embodiment, the paint oven 20 further includes a plurality of calibration targets 30 which are monitored by the infrared temperature sensors 28 when a painted vehicle body 26 does not block the “view” of the infrared temperature sensors 28 as described below. This embodiment of the paint oven 20 further includes a laser 32 which monitors the passage of vehicle bodies 26 similar to the laser of a garage door opener system. Purge air 34 is directed into the infrared temperature sensor assemblies as described below and the system includes a control 36.

As described below, the infrared temperature sensors 28 are aligned and directed toward predetermined areas of the painted vehicle body 26 to measure the temperature of the predetermined areas as the painted vehicle bodies 26 are conveyed through the oven 20 on the conveyor 24. The data collected from the infrared temperature sensors 28 is transmitted to the control 36 and utilized as described below. When a vehicle body 26 is not located between the infrared temperature sensors 28 and the calibration targets 30, the infrared temperature sensors measure the temperature of the calibration targets 30. In one preferred embodiment, the temperature of the calibration targets 30 is independently measured and monitored and the data is also transmitted to the control 36. The temperature of the calibration targets may be measured by thermocouples, resistance temperature detectors or other convenient temperature sensors. As described below, the temperature measured by the infrared sensors 28 is then compared to the independently determined temperature of the calibration targets 30 which then may be utilized as discussed below.

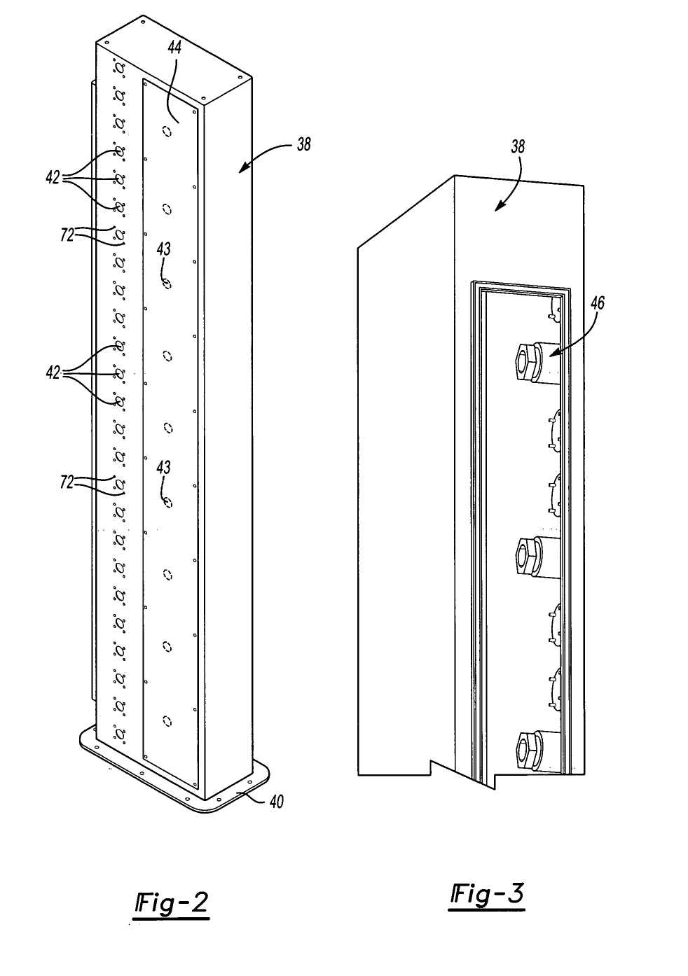

FIGS. 2 and 3 illustrate one preferred embodiment of oven temperature measurement system which may be easily added to existing paint ovens to monitor the temperature of predetermined areas of painted articles. The temperature monitoring system in this embodiment is housed in a cabinet, housing or enclosure 38 having a base 40 for mounting the housing 38 in the oven. The temperature monitoring system includes a plurality of vertically aligned apertures 42 which receive the infrared temperature sensors (described below) on one side and a calibration plate 44 on the other side. The calibration plate 44 may be formed of black anodized aluminum, for example, or any other temperature stable material. As stated herein, in one embodiment of this invention, the temperature of the calibration targets 44 is independently measured for calibration of the infrared temperature sensors. In the embodiment of the calibration target 44 shown in FIG. 2, thermocouples 43 are located behind the calibration target 44 and to measure the temperature of the calibration target 43. The temperatures measured by the thermocouples 43 are then transmitted to the control 36. In FIG. 3, the door of the housing 38 has been removed to show the mounting of the infrared temperature sensor assemblies 46 described below.

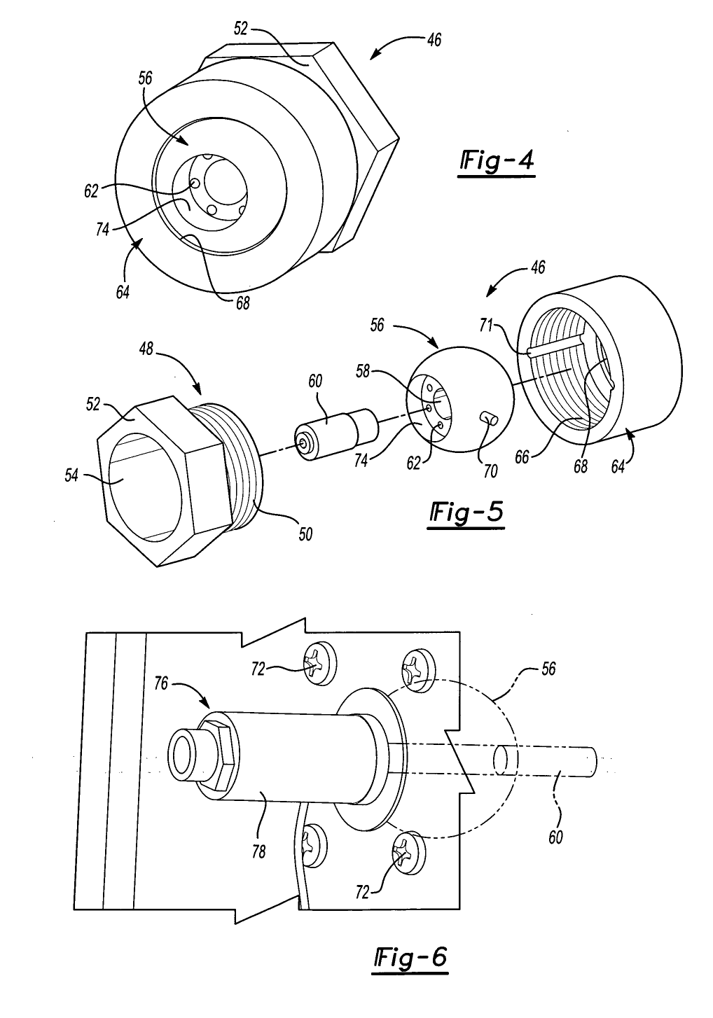

FIGS. 4 and 5 illustrate one embodiment of an infrared temperature adjustable mounting assembly 46. The disclosed embodiment of the infrared temperature sensor mounting assembly 46 includes a bushing 48 having an externally threaded nipple portion 50 and a polygonal body portion 52 having a cylindrical aperture 54. A spherical ball mount 56 having a cylindrical-opening 58 receives the infrared temperature sensor 60 as shown in FIG. 5. In this embodiment, the ball mount 56 includes a plurality of air passages 62 as shown in FIGS. 4 and 5. The spherical ball mount 56 and infrared temperature sensors 60 are retained in the cylindrical aperture 54 of the bushing 48 by ring member 64 having an internally threaded bore 66 which threadably receives the externally threaded nipple portion 50 of the bushing 48. As will be understood by those skilled in this art, the orientation of the infrared temperature sensor 60 may be easily adjusted by moving the ball mount 56 to the desired orientation of the infrared sensor 60 and then threading the threaded nipple portion 50 of the bushing 48 into the internally threaded ring member, locking the desired orientation of the infrared temperature sensor 60. The ring member 64 further includes an aperture 68 which provides a field of view for the infrared temperature sensors 60 and the ball mount 56 includes a cylindrical opening 74.

The infrared temperature sensors 60 in FIG. 5 and 28 in FIG. 1 may be of the integrated type where the sensor and electronics are integrated into a single enclosure, such as the Thermalert MM made by Raytek of Santa Cruz, Calif. These systems can operate in ambient temperatures up to about 50° C. to 60° C. (122° F.-140° F.). With these systems, the housing 38 would need to be insulated and supplied with a high volume of air through apertures 62 to keep the sensors within their operating limits. Alternatively, the infrared temperature sensors may be of the “split” type where the sensor head is separated from the electronics by a cable, such as the Optris CT, made by Micro-Epsilon of Raleigh, N.C. The sensing head for these types of sensors is capable of operating in ambient temperature up to about 180° C. (356° F.). With a sensor of this type, no cooling of the sensor or insulation of the housing is required. Finally, the infrared sensors may be of “fiber optic” type where the infrared energy from the object travels through a fiber optic cable to a sensor located some distance away. The fiber optic cable has a lens assembly on the end that views the object. One example of this type of sensor is the M680 Infraducer made by Micron of Oakland, N.J. With this type of system, the fiber optic cable and lens assembly are capable of operating at ambient temperatures up to 500° C. (900° F.). With a sensor of this type, no cooling of the sensor or insulation of the housing 38 is required. Thus, the purge air openings 60 are optional. In one preferred embodiment, the ball mount 56 includes coaxially aligned pivot pins 70 which are received in slots 71 in the threaded opening 66 of the ring member 64. The pivot pins 70 permit adjustment of the infrared temperature sensors 60 up and down or about the axis of the pins 70, preventing the infrared temperature sensors from being adjusted from side to side which could result in adjusting the infrared temperature sensors 60 such that the infrared temperature sensors cannot measure the temperature of the calibration targets 44.

FIG. 6 illustrates one preferred method of aligning the infrared temperature sensors 60 shown in FIG. 5 with a predetermined location on a painted article in a paint oven. As will be understood by those skilled in this art, the infrared temperature sensor does not project a beam or other visual indication of the orientation of the infrared temperature sensor 60. As shown in FIG. 6, a laser 76 may be aligned with the infrared temperature sensor 60 shown in FIG. 5. In this embodiment, the laser 76 includes a cylindrical body or enclosure 78 having an outside diameter substantially equal to the internal diameter of the cylindrical opening 74 of the ball mount 56 shown in FIGS. 4 and 5. The cylindrical body or enclosure 78 is simply inserted into the cylindrical opening 74 in the ball mount 56, thereby aligning the laser 76 with the infrared temperature sensor 60. Thus, the laser 76 may be utilized to align the infrared temperature sensor 60 with the area of the vehicle body 26 where a temperature measurement is desired. When the laser 76 is properly aligned with the predetermined area of the vehicle body, the bushing 48 is tightened by rotating the hexagonal body portion 52 into the ring member 64, locking the orientation of the infrared temperature sensor 60 in the desired orientation. This method is repeated for each of the infrared temperature sensors 28. Although a laser may be preferred, any light projector may be utilized. The infrared temperature sensors 60 may also be easily realigned by this method for different applications, such as different vehicle bodies.

During periods when no painted object 26 is located in front of the infrared sensors 28 shown in FIG. 1, the electronic control 36 may compare the signal received from the infrared sensors 28 to the temperature independently measured of the calibration targets 30. As set forth above, the temperature of the calibration targets 30 may independently measured a thermocouple of the like and the temperature of the calibration targets 30 measured by the infrared temperature sensors 28 may then be compared with the independently measured temperature of the of the calibration target 30. If the signal from the infrared sensors disagrees with the temperature independently measured on the calibration target 30 beyond some predetermined limit, the electronic control system may then take one or more of the following actions: Signal the oven operator that the infrared signal is out of calibration; Correct the signal from the infrared temperature sensor by applying or adjusting a mathematical correction factor; or Record the readings along with information about the date, time or other conditions for future verification. During the period when the oven is being heated, the electronic control system 36 may record the signal from the infrared sensors and the calibration target sensors. It may use this information to create a calibration curve that correlates the infrared sensor output to the calibration target temperature. This calibration curve may be continuously used to convert the signal from the infrared sensors to actual temperature during system operation.

The method of monitoring the temperature of painted articles in a paint oven 20 of this invention thus includes conveying the painted articles, such as the painted vehicle bodies 26 shown in FIG. 1, through the paint oven, such as by conveyor 24, measuring the temperature of predetermined areas of the painted articles by directing infrared temperature sensors 30 at the predetermined areas of the painted articles and transferring the data from the infrared temperature sensors 30 to a control 36 as described above. In a preferred embodiment of the method of this invention, the temperature data measured by the infrared temperature sensors is compared by the control 36 to predetermined standards and the control may then signal the oven operator if the temperatures measured are outside a predetermined range. As set forth above, the electronic control 36 of the paint oven 20 of this invention may also be used to recognize the painted object conveyed through the oven. The temperatures measured by the infrared temperature sensors 28 in FIG. 1 will normally be within predetermined ranges for each painted article, such as the vehicle body 26, providing a temperature “signature” to the control 36 for each vehicle body model conveyed through the paint cure oven 20. The control may then compare the temperature signatures with a standard for each vehicle body model and select the standard that most closely matches. The control 36 may then compare the temperatures sensed by the infrared temperature sensors with the predetermined standard for the selected vehicle body model and signal the operator when a temperature sensed is outside of a predetermined range. Further, the control 36 may be utilized to control the temperature of the oven based upon the temperatures measured by the infrared sensors 28 in FIG. 1 and 60 in FIG. 5. As will be understood by those skilled in this art, the temperature of the paint oven 20 is typically controlled by burners and ducts which transfer air heated by the burners (not shown) through the oven and the control 36 may be utilized to control the temperature of the paint oven 20 or locations within the paint oven based upon the temperatures measured by the infrared temperature sensors 28.

In one preferred embodiment, the method of this invention further includes directing the infrared temperature sensors 28 at calibration targets 30, independently measuring the temperature of the calibration targets 30 and comparing the temperature of the calibration targets 30 measured by the infrared temperature sensors 28 and the temperature of the calibration targets 30 independently measured for calibration of the infrared temperature sensors, such as the thermocouples 43 in FIG. 2. Although preferred, however, this additional method step is optional. Further, in a preferred embodiment, the method of this invention includes aligning a light source, such as the laser 76 shown in FIG. 6, with the infrared temperature sensor 60 and adjusting the orientation of the light source and the infrared temperature sensor 60 toward a predetermined area of the painted article in the oven, then removing the light source and preferably-locking the orientation sensor 60.

Having described a preferred embodiment of the paint oven and method of monitoring the temperature of painted articles of this invention, it will be understood that various modifications may be made within the purview of the appended claims as set forth above. For example, the infrared temperature sensors may be mounted by any suitable assembly, but is preferably adjustable to direct the infrared temperature sensor to predetermined areas of the painted article in the paint oven. Further, this invention may be applied to any type of paint oven, including pre-existing paint ovens. In a preferred embodiment for existing ovens, the infrared temperature sensors are enclosed within freestanding housings, such as shown at 38 in FIGS. 2 and 3, wherein the temperature sensors are located on opposed sides of the painted article 26 and the painted article is preferably transferred through the oven on a conveyor 24 as shown in FIG. 1. Further, as set forth above, the paint oven of this invention preferably includes calibration targets or calibration plates. However, calibration targets are considered optional. Having described preferred embodiments of this invention, the invention is now claimed as follows.

1. A paint oven, comprising:
a heated oven enclosure;
a conveyor conveying painted articles through said heated oven enclosure curing the paint on the articles;
a plurality of infrared temperature sensors directed toward and measuring the temperature of predetermined areas of said painted articles conveyed through said heated oven enclosure; and
a control receiving a signal from said infrared temperature sensors and comparing said signal to a predetermined standard.

2. The paint oven as defined in claim 1, wherein said paint oven further includes a plurality of calibration targets opposite said infrared temperature sensors on an opposite sides of said conveyor, such that said infrared temperature sensors measure the temperature of said calibration targets when said painted articles do not block the view of said infrared temperature sensors and said calibration targets including independent temperature sensors for calibration of said infrared temperature sensors.

3. The paint oven as defined in claim 2, wherein said control compares the temperature measured by said infrared temperature sensors with the temperature measured by said independent temperature sensors.

4. The paint oven as defined in claim 1, wherein said control is connected to a source of heat of said heated oven enclosure and said control adjusting the heat supplied to predetermined areas of said heated oven enclosure to achieve a predetermined temperature of said predetermined areas of said painted articles.

5. The paint oven as defined in claim 1, wherein infrared temperature sensors are adjustably mounted in said paint oven.

6. The paint oven as defined in claim 5, wherein said infrared temperature sensors are each mounted in a generally spherical ball, permitting adjustment of the orientation of said infrared temperature sensors.

7. The paint oven as defined in claim 1, wherein said paint oven includes housings on opposed sides of said conveyor, each housing including a plurality of said infrared temperature sensors.

8. The paint oven as defined in claim 7, wherein said housings each include a calibration target.

9. The paint oven as defined in claim 7, wherein said housings each include a calibration target in a line of sight of said infrared temperature sensors each having a independent temperature sensor for calibration of said infrared temperature sensors.

10. The paint oven as defined in claim 1, wherein said control signals an operator in the event that the signal from the infrared temperature sensors differs from said predetermined standard by a predetermined amount.

11. A paint oven, comprising:
a heated oven enclosure;
a conveyor conveying painted articles through said oven enclosure curing the paint on said articles;
a plurality of infrared temperature sensors directed toward and measuring the temperature of predetermined areas of said painted articles conveyed through said heated oven enclosure; and
a calibration target located opposite said infrared temperature sensors on an opposite side of said conveyor, such that said infrared temperature sensors measure the temperature of said calibration targets when said articles do not block said infrared temperature sensors, and said calibration targets including independent temperature sensors for calibration of said infrared temperature sensors.

12. The paint oven as defined in claim 11, wherein said paint oven further includes a control receiving a signal from said infrared temperature sensors and comparing said signal to a predetermined standard.

13. The paint oven as defined in claim 11, wherein said control is connected to said independent sensors and said control comparing the temperatures measured by said infrared sensors with the temperatures measured by said independent sensors.

14. The paint oven as defined in claim 13, wherein said control signals an operator in the event that the temperature measured by said infrared temperature sensors differ from the temperatures measured by said independent sensors by a predetermined amount.

15. The paint oven as defined in claim 11, wherein said paint oven includes a control receiving a signal from said infrared temperature sensors and said control comparing said signal with a predetermined standard.

16. The paint oven as defined in claim 15, wherein said control signals an operator in the event that said signal differs from said standard a predetermined amount.

17. The paint oven as defined in claim 11, wherein said paint oven further includes cabinets on opposed sides of said conveyor, each cabinet including said plurality of infrared sensors and a calibration target.

18. The paint oven as defined in claim 11, wherein said plurality of infrared temperature sensors are located within said heated oven enclosure.

19. A method of monitoring the temperature of predetermined locations of painted articles in a paint cure oven, comprising the following steps:
conveying painted articles through a heated paint oven, curing the paint on the articles;
measuring the temperature of predetermined areas of the painted articles by directing infrared temperature sensors at said predetermined areas; and
transferring data from infrared temperature sensors to a control and said control comparing the temperature measured by said infrared temperature sensors with a predetermined standard.

20. The method as defined in claim 19, wherein said method further includes directing said infrared temperature sensors to a calibration target, independently measuring the temperature of said calibration target, and calibrating said infrared temperature sensors.

21. The method as defined in claim 19, wherein said method further includes aligning each of the infrared temperature sensors with a predetermined area of the painted articles by aligning a light source with an infrared temperature sensor, adjusting the alignment of the light source and the infrared temperature sensor to direct the light source to a predetermined area of the painted article and then removing the light source.

22. The method as defined in claim 21, wherein said method includes coaxially aligning a laser with each of said infrared temperature sensors.

23. The method as defined in claim 19, wherein said method includes conveying different painted articles through the paint cure oven, and the control comparing the temperatures measured by the infrared temperature sensors with a standard for each type of painted article to determine the number of each type of painted articles conveyed through the paint cure oven.

24. The method as defined in claim 19, wherein said method includes conveying different types of painted articles through the paint cure oven, and the control comparing the temperatures measured by the infrared temperature sensors of the predetermined areas with a standard for each type of painted article, selecting a standard which most closely matches the type of painted article and then determining whether the temperatures measured by the infrared temperature sensors are within a predetermined range for the selected type of painted article.

25. The method as defined in claim 24, wherein the control signals an oven operator if the temperatures measured are outside the predetermined range.

26. A method of monitoring the temperature of painted vehicle bodies in a paint oven, comprising the following steps:
conveying painted vehicle bodies through a heated paint oven curing the paint on said vehicle bodies;
measuring the temperature of predetermined areas of the painted vehicle bodies in the paint oven by directing infrared temperature sensors at the predetermined areas; and
periodically calibrating the infrared temperature sensors by directing the infrared sensors toward a calibration target and independently measuring the temperature of the calibration target.

27. The method as defined in claim 26, wherein said method further includes aligning each of said the infrared temperature sensors with a predetermined area of the painted articles by aligning a laser with an infrared temperature sensor, adjusting the alignment of the laser and the infrared temperature sensor to direct the laser to a predetermined area of the painted article and then removing the laser.

28. The method as defined in claim 26, wherein said method include conveying different types of painted articles through the paint oven and a control comparing the temperatures measured by the infrared temperature sensors of the predetermined areas of a painted article with a standard for each type of painted articles, selecting a standard which most closely matches the type of painted article and then determining whether the temperatures measured by the infrared sensors are within a predetermined range for the selected type of painted article.
